(19) United States
(12) Patent Application Publication
(10) Pub. No.: US 2007/0203983 A1
(43) Pub. Date: Aug. 30, 2007

(54) Server

(75) Inventors: Ryuji Fukuhara, Fukuoka (JP); Junji Tagane, Fukuoka (JP); Ryouji Nakamatsu, Fukuoka (JP); Takashi Yoshiyama, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/706,210

(22) Filed: Feb. 15, 2007

(30) Foreign Application Priority Data
Feb. 15, 2006 (JP) 2006-037410

(51) Int. Cl. G06F 15/16

(52) U.S. Cl. 709/204

(57) ABSTRACT

A server capable of reducing an overloaded state even if a refreshing message is frequently generated. A central processing unit receives a first message transmitted from a terminal to establish a session. The central processing unit, when receiving the first message from the terminal, allocates to itself and the other plural central processing units the subsequent message transmission and reception between the terminal and a terminal as a communication partner. The central processing unit allocates to itself and the other plural central processing units the message transmission and reception between the terminals, for example, in a round robin fashion.

### CROSS-REFERENCE TO RELATED APPLICATIONS

This application is based upon and claims the benefits of priority from the prior Japanese Patent Application No. 2006-037410, filed on Feb. 15, 2006, the entire contents of which are incorporated herein by reference.

### BACKGROUND OF THE INVENTION

1. Field of the Invention

The present invention relates to a server. More particularly, the present invention relates to a server for establishing and maintaining a session between terminals.

2. Description of the Related Art

In an Internet Protocol (IP) network using a Session Initiation Protocol (SIP), a User Agent Client and a User Agent Server establish a session through a SIP server to perform communication. After establishing the session, the User Agent Client and the User Agent Server perform an existence check on the session, using a session timer function specified in RFC 4028.

FIG. 26 is a sequence diagram illustrating the existence check on the session. The figure shows a sequence among a User Agent Client (hereinafter, referred to as a UAC), a SIP server and a User Agent Server (hereinafter, referred to as a UAS).

A Session-Expires header exists in a SIP message. During a call placing, the UAC and the UAS negotiate a survival time of a session (hereinafter, referred to as a session timer) using the Session-Expires header of an INVITE message. After coming into a communication state, the UAC and the UAS check the normality of the session as follows. That is, one party transmits the INVITE message at a time period of half the session timer value and receives a response from the other party.

Here, a timer used for transmitting the INVITE message at a time period of half the session timer value is referred to as a refresh timer. A terminal after completing the checking of normality of the session updates the session timer and then repeats the same operation.

Each step in the figure will be described below.

[Step S101] In order to initiate communication with the UAS, the UAC transmits the INVITE message to a SIP server (hereinafter, referred to as a server). In order to negotiate the session timer with the UAS, the UAC performs the transmission including a session timer value of, for example, 1800 seconds in the Session-Expires header of this first INVITE message.

[Step S102] The server transmits to the UAS the INVITE message received from the UAC.

[Step S103] The UAS, when receiving the INVITE message from the server, transmits a 200OK message to the server. Here, the UAS performs the transmission including a session timer value of, for example, 1800 seconds in the Session-Expires header of the 200OK message. Further, the UAS, in the wake of the first transmission of the 200OK message, sets a session timer to 1790 seconds resulting from subtracting 10 seconds from 1800 seconds.

[Step S104] The server transmits to the UAC the 200OK message received from the UAS.

The UAC, in the wake of the first reception of the 200OK message, sets a session timer to 1790 seconds resulting from subtracting 10 seconds from 1800 seconds. Further, the UAC sets a refresh timer to 900 seconds which is half of 1800 seconds.

[Step S105] The UAC, in response to the 200OK message, transmits an ACK message to the server. The UAC, when receiving the 200OK message from the UAS, recognizes that the negotiation of the session timer is completed.

[Step S106] The server transmits to the UAS the ACK message from the UAC.

[Step S107] The UAC and UAS establish a SIP session therebetween and then initiate communication with each other.

[Step S108] The UAC, when 900 seconds as a refresh timer expires, transmits a refreshing INVITE message (for updating the session timer and the refresh timer) to the server.

[Step S109] The server transmits to the UAS the INVITE message received from the UAC.

[Step S110] The UAS, when receiving the INVITE message from the server, transmits the 200OK message to the server. The UAS, in the wake of the reception of the INVITE message from the server, updates the session timer. The UAS, when receiving no refreshing INVITE message from the server within 1790 seconds, interrupts the session.

[Step S111] The server transmits to the UAC the 200OK message received from the UAS.

The UAC, in the wake of the reception of the 200OK message from the server, updates the session timer and the refresh timer. The UAC, when receiving no 200OK message from the server within 1790 seconds, interrupts the session.

[Step S112] The UAC, in response to the 200OK message, transmits the ACK message to the server.

[Step S113] The server transmits to the UAS the ACK message from the UAC. Subsequently, the UAC and the UAS repeats the same refresh operation as described above.

In RFC 4028, the session timer is specified such that 1800 seconds is a recommended value and at least 90 seconds or more is set for the session timer.

When the session timer is set to 180 seconds, for example, in a telephone session, the existence check on the session is performed in 170 seconds. Accordingly, in the case where the charging unit time of communication is 180 seconds, even if the communication is interrupted by some cause such as network troubles, the existence check on the session fails in 170 seconds and the session is opened within the charging unit time, so that erroneous charging can be prevented.

Meanwhile, there is conventionally provided a communication terminal in which a protocol type is previously determined corresponding to a port number (see, e.g., Japanese Unexamined Patent Publication No. 2004-363993).

However, when a session timer is set to be short, refreshing messages are frequently generated and as a result, excessive traffic is generated on the server to cause an overloaded state of the server.

In Japanese Unexamined Patent Publication No. 2004-363993, reception ports differ according to protocols. However, when traffic of one protocol becomes excessive, a port corresponding to the protocol also comes into an overloaded state.

### SUMMARY OF THE INVENTION

In view of the foregoing, it is an object of the present invention to provide a server in which by distributing the message transmission and reception between terminals to plural central processing units, an overloaded state can be reduced even if messages are frequently generated.

To accomplish the above object, according to the present invention, there is provided a server for establishing and maintaining a session between terminals. The server comprises: a central processing unit for receiving a first message transmitted from a terminal to establish the session and for allocating, to one of the central processing unit and other plural central processing units, subsequent message transmission and reception between the terminal and a terminal as a communication partner.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows an outline of a server.

FIG. 2 shows a system configuration example of a SIP server according to a first embodiment.

FIG. 3 illustrates a port of the SIP server.

FIG. 4 illustrates allocation of CPUs to ports.

FIG. 5 is a functional block diagram of the SIP server.

FIG. 6 is a sequence diagram showing operations of the session establishment between terminals.

FIG. 7 shows an example of an initial INVITE message transmitted to the SIP server from the terminal.

FIG. 8 shows an example of the initial INVITE message transmitted to the terminal from the SIP server.

FIG. 9 shows an example of a 200OK message transmitted to the SIP server from the terminal.

FIG. 10 shows an example of the 200OK message transmitted to the terminal from the SIP server.

FIG. 11 shows an example of an ACK message transmitted to the SIP server from the terminal.

FIG. 12 shows an example of the ACK message transmitted to the terminal from the SIP server.

FIG. 13 is a sequence diagram showing operations of an existence check on the session between terminals.

FIG. 14 shows an example of a refresh INVITE message transmitted to the SIP server from the terminal.

FIG. 15 shows an example of the refresh INVITE message transmitted to the terminal from the SIP server.

FIG. 16 shows an example of the 200OK message transmitted to the SIP server from the terminal.

FIG. 17 shows an example of the 200OK message transmitted to the terminal from the SIP server.

FIG. 18 shows an example of the ACK message transmitted to the SIP server from the terminal.

FIG. 19 shows an example of the ACK message transmitted to the terminal from the SIP server.

FIG. 20 illustrates a port allocation in the SIP server according to a second embodiment.

FIG. 21 is a functional block diagram of the SIP server.

FIG. 22 is a flowchart showing operations of a port distribution in the SIP server.

FIG. 23 illustrates a port allocation in the SIP server according to a third embodiment.

FIG. 24 is a functional block diagram of the SIP server.

FIG. 25 is a flowchart showing operations of a port distribution in the SIP server.

FIG. 26 is a sequence diagram for illustrating the existence check on the session.

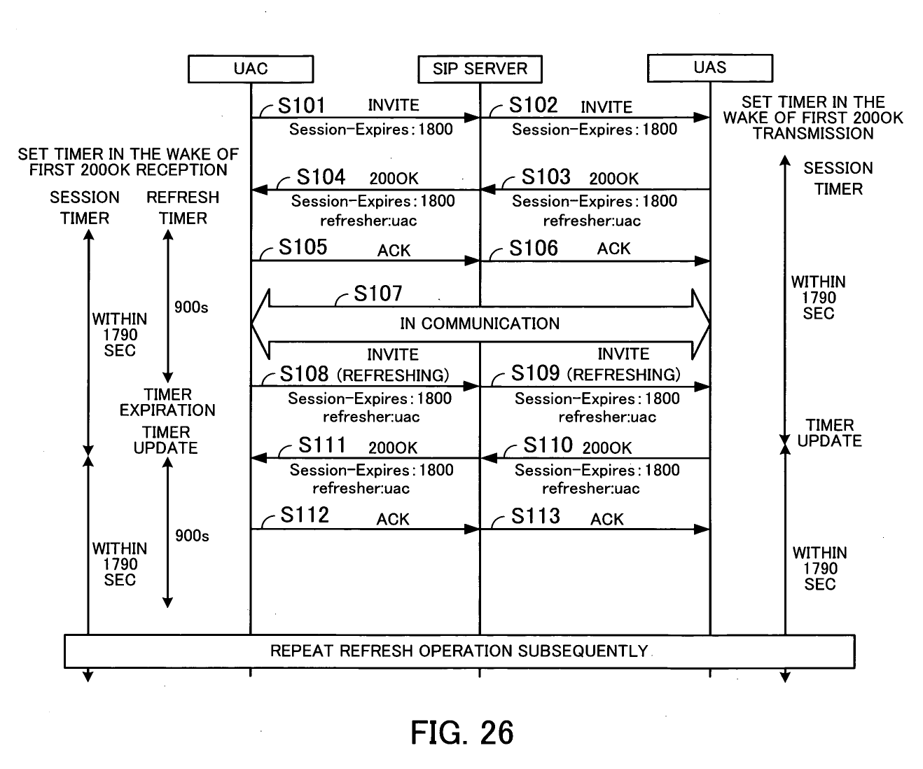

### DESCRIPTION OF THE PREFERRED EMBODIMENTS

A principle of the present invention will be described in detail below with reference to the accompanying drawings, wherein like reference numerals refer to like elements throughout.

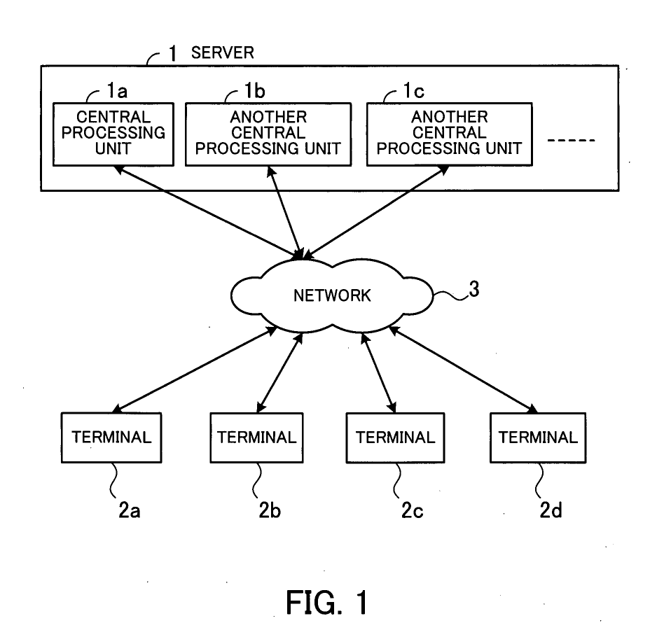

FIG. 1 shows an outline of a server. A server 1 is connected to terminals 2a to 2d through a network 3. The server 1 has a central processing unit 1a and the other plural central processing units 1b, 1c, . . . . The server 1 establishes and maintains a session between the terminals 2a to 2d.

The central processing unit 1a receives a first message transmitted from the terminals 2a to 2d to establish a session. The central processing unit 1a, when receiving the first message from the terminals 2a to 2d, allocates to itself and the other central processing units 1b, 1c, . . . the subsequent message transmission and reception between the terminals 2a to 2d, and terminals 2a to 2d as communication partners.

For example, assume that the terminal 2a transmits a message (a first message) to the central processing unit 1a to establish a session with the terminal 2b. The central processing unit 1a, when receiving the first message from the terminal 2a, allocates to itself the subsequent message transmission and reception between the terminals 2a and 2b.

Next, assume that the terminal 2c transmits a message (a first message) to the central processing unit 1a to establish a session with the terminal 2d. The central processing unit 1a, when receiving the first message from the terminal 2c, allocates to another central processing unit 1b the subsequent message transmission and reception between the terminals 2c and 2d.

The central processing unit 1a performs allocation of the message transmission and reception, for example, in a round robin fashion. Accordingly, the unit 1a, after allocating to itself the message transmission and reception between the terminals 2a and 2b, allocates to another central processing unit 1b the next message transmission and reception between the terminals 2c and 2d, as described above. Thereafter, the unit 1a sequentially allocates the message transmission and reception to the other central processing units 1c, . . . , When allocating the message transmission and reception to the other central processing units, the unit 1a again allocates to itself the message transmission and reception.

Thus, the central processing unit 1a receives a first message transmitted from the terminals 2a to 2d to establish a session. Then, the unit 1a allocates to itself and the other central processing units 1b, 1c, . . . the subsequent message transmission and reception between the terminals 2a to 2d and the terminals 2a to 2d as communication partners. As a result, since the message transmission and reception between the terminals 2a to 2d is distributed into the central processing unit 1a and the other central processing units 1b, 1c, . . . , an overloaded state of the server 1 can be reduced even if messages are frequently generated.

Next, a first embodiment in which the server according to the present invention is applied to the SIP server will be described in detail below with reference to the accompanying drawings.

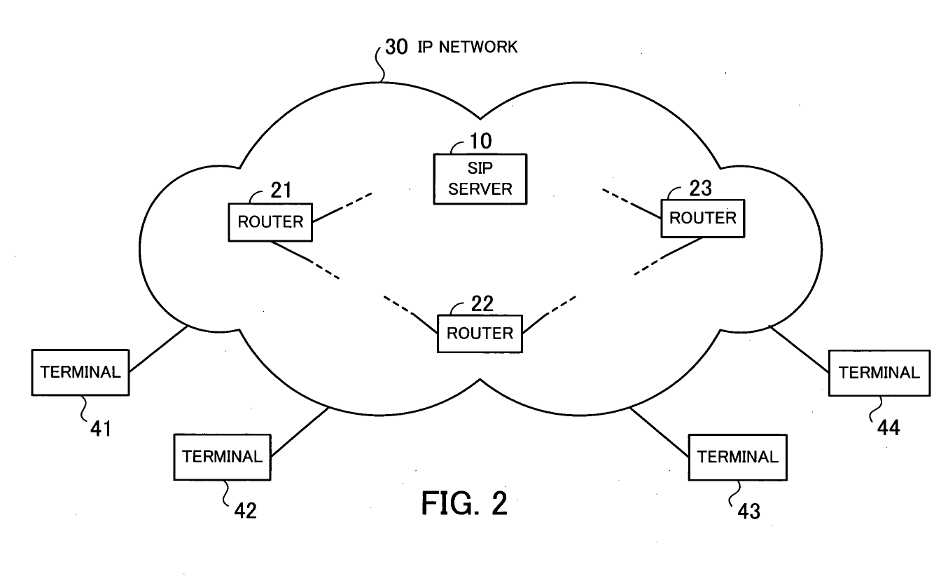

FIG. 2 shows a system configuration example of the SIP server according to the first embodiment. As shown in the figure, an IP network 30 has a SIP server 10 and routers 21 to 23. To the IP network 30, terminals 41 to 44 are connected. The terminals 41 to 44 establish a session through the SIP server 10 and perform communication therethrough.

The terminals 41 to 44, when setting a session timer to be short, frequently generate refreshing messages (INVITE/200OK/ACK messages). As a result, excessive traffic may be generated on the SIP server 10 to cause an overloaded state of the server 10.

For example, the terminals 41 to 44 set the session timer to 180 seconds. This value is one tenth of 1800 seconds which is a recommended value for the SIP. Therefore, the refreshing messages are frequently generated. As a result, excessive traffic may be generated on the SIP server 10 to cause an overloaded state of the server 10.

Accordingly, the SIP server 10 opens plural ports for User Datagram Protocol (UDP) and allocates a Central Processing Unit (CPU) to each port. As a result, since the frequently generated messages are distributed into each CPU, the SIP server 10 can reduce the excessive traffic as well as can reduce the overloaded state. Here, the port of the SIP server 10 will be described.

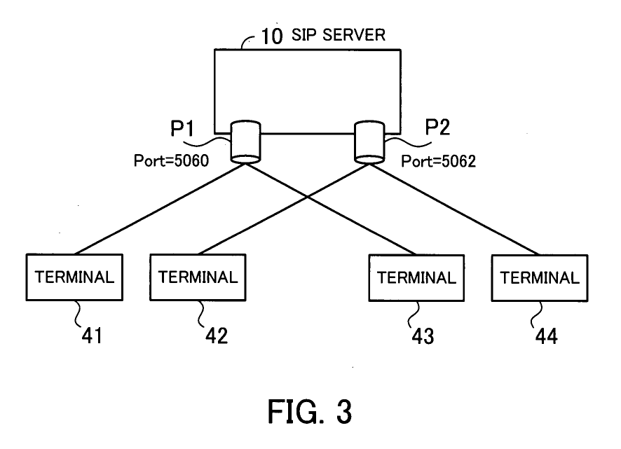

FIG. 3 illustrates the port of the SIP server. As shown in FIG. 3, the SIP server 10 opens two UDP ports P1 and P2. A port number of the port P1 is, for example, 5060 (a well-known port number for SIP is 5060) and that of the port P2 is 5062.

The SIP server 10, for example, performs a call processing between the terminals 41 and 43 through the port P1 and performs a call processing between the terminals 42 and 44 through the port P2. Further, the SIP server 10 performs a message processing in the CPU allocated to each of the ports P1 and P2.

The amount of signals receivable through one port (a size of one signal×the number of signals) is restricted by a receiving memory area secured in the Operating System (OS). For example, in the case of using Solaris, the receiving memory area is restricted to 64 k bytes.

A conventional SIP server performs the message transmission and reception through one port having the number of 5060 which is a well-known port number for SIP. Therefore, when a signal unable to be extracted from the receiving memory area by an application which executes the call processing on the OS concentrates on the above port, the signal in excess of the capacity of the receiving memory area is discarded by the OS.

On the other hand, the SIP server 10 opens plural ports and allocates a CPU to each port. Accordingly, the SIP server 10 can reduce excessive traffic as well as can reduce the overloaded state even if refreshing messages are generated frequently.

Even if plural ports are opened for one CPU, the overloaded state of the SIP server 10 is unable to be reduced by the convergence of CPUs.

Next, allocation of CPUs to ports will be described.

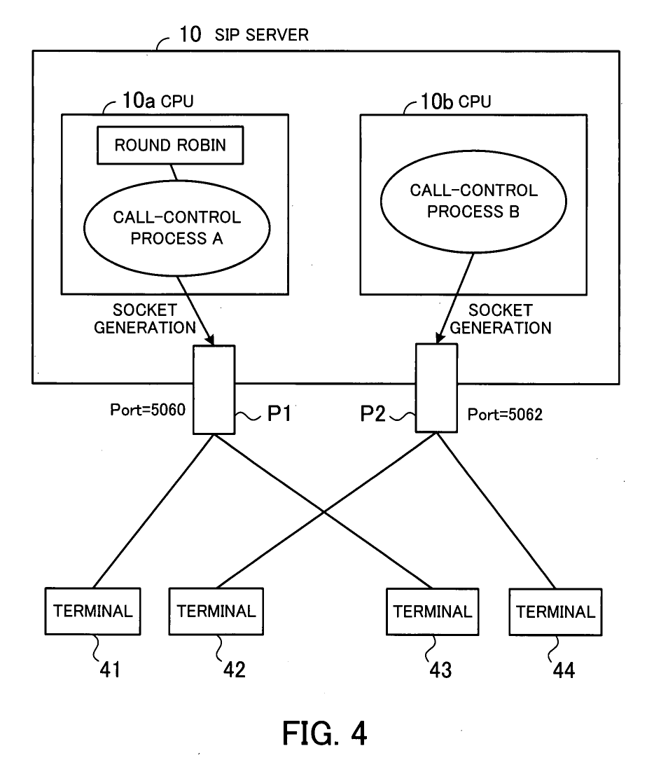

FIG. 4 illustrates allocation of the CPUs to the ports. As shown in the figure, the SIP server 10 has CPUs 10a and 10b. FIG. 4 also shows the terminals 41 to 44. A call-control process A is allocated to the CPU 10a and a call-control process B is allocated to the CPU 10b. The call-control processes A and B perform a call processing based on the SIP for establishing and maintaining a session.

Each of the call-control processes A and B opens a socket for the port. For example, the call-control process A opens a socket for the port, P1 (port number: 5060) and the call-control process B opens a socket for the port P2 (port number: 5062). Thus, the CPU 10a has one port P1 and the CPU 10b has one port P2.

The terminals 41 to 44 perform a first call to the port P1 of the SIP server 10 by default. More specifically, the terminals 41 to 44 transmit a call setting message (the first message, e.g., the first INVITE message) to the port P1 by default to establish the session.

The call-control process A, when receiving the call setting message from the terminals 41 to 44, allocates to the ports P1 and P2 in a round-robin fashion the subsequent message exchange between the terminals 41 to 44 which generate the call setting message and the terminals 41 to 44 as communication partners.

For example, assume that a call is performed from the terminal 41 to the terminal 43. In this case, the call-control process A controls such that the subsequent message exchange between the terminals 41 and 43 is performed through the port P1.

Next, assume that a call is performed from the terminal 42 to the terminal 44. In this case, the call-control process A controls such that the subsequent message exchange between the terminals 42 and 44 is performed through the port P2.

Further, assume that a call is performed from one terminal to another terminal not shown. In this case, the call-control process A controls such that the subsequent message exchange between these terminals is performed through the port P1. Thereafter, in the same manner as above, the call-control process A controls such that the subsequent message exchange between the terminals 41 to 44 is alternately allocated to the ports P1 and P2.

Thus, the message exchange between the terminals 41 to 44 is allocated alternately to the ports P1 and P2 and therefore, the call processing is evenly allocated to the call-control processes A and B. As a result, the CPUs 10a and 10b can reduce the overloaded state.

Alternatively, the call-control process B may perform allocation control to the ports P1 and P2. In this case, the terminals 41 to 44 must transmit a call setting message to the port P2 by default.

FIG. 4 shows a distribution configuration using two CPUs. Further, the number of CPUs used may be three or more.

Next, a function of the SIP server 10 will be described.

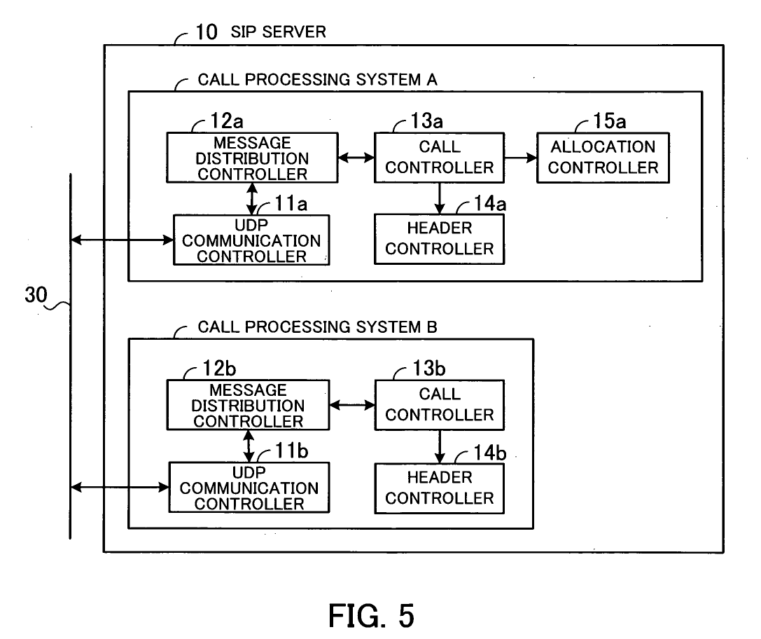

FIG. 5 is a functional block diagram of the SIP server. As shown in the figure, the function of the SIP server 10 is divided into that of a call processing system A and that of a call processing system B. The function of the call processing system A is realized by the CPU 10a shown in FIG. 4 and the function of the call processing system B is realized by the CPU 10b shown in FIG. 4. FIG. 5 also shows the IP network 30 shown in FIG. 2.

The call processing system A has a UDP communication controller 11a, a message distribution controller 12a, a call controller 13a, a header controller 14a and an allocation controller 15a. The call processing system B has a UDP communication controller 11b, a message distribution controller 12b, a call controller 13b and a header controller 14b.

The UDP communication controllers 11a and 11b manage the ports P1 and P2 as well as control the transmission and reception of UDP signals.

The message distribution controllers 12a and 12b analyze the received UDP signal and determine whether the UDP signal is a signal to be received by themselves. The message distribution controllers 12a and 12b, when the UDP signal is a signal to be received by themselves, output the signal to the call controllers 13a and 13b.

The call controllers 13a and 13b perform a call processing based on the SIP. Further, the call controller 13a, when receiving a call setting message from the terminals 41 to 44, issues an instruction to the header controller 14a to allow the subsequent message exchange between the terminals 41 to 44 which generate a call setting message and the terminals 41 to 44 as communication partners to be allocated to the ports P1 and P2 based on the allocation result of the allocation controller 15a.

The header controllers 14a and 14b perform a header control corresponding to the SIP by the header generation and editing instructions from the call controllers 13a and 13b.

The allocation controller 15a, when receiving a call setting message from the terminals 41 to 44, allocates to the ports P1 and P2 in a round-robin fashion the subsequent message exchange between the terminals 41 to 44 which generate the call setting message and the terminals 41 to 44 as communication partners.

Next, operations of the session establishment and of existence check on the session between the terminals 41 to 44 will be described. First, the operations of the session establishment between the terminals 41 to 44 will be described.

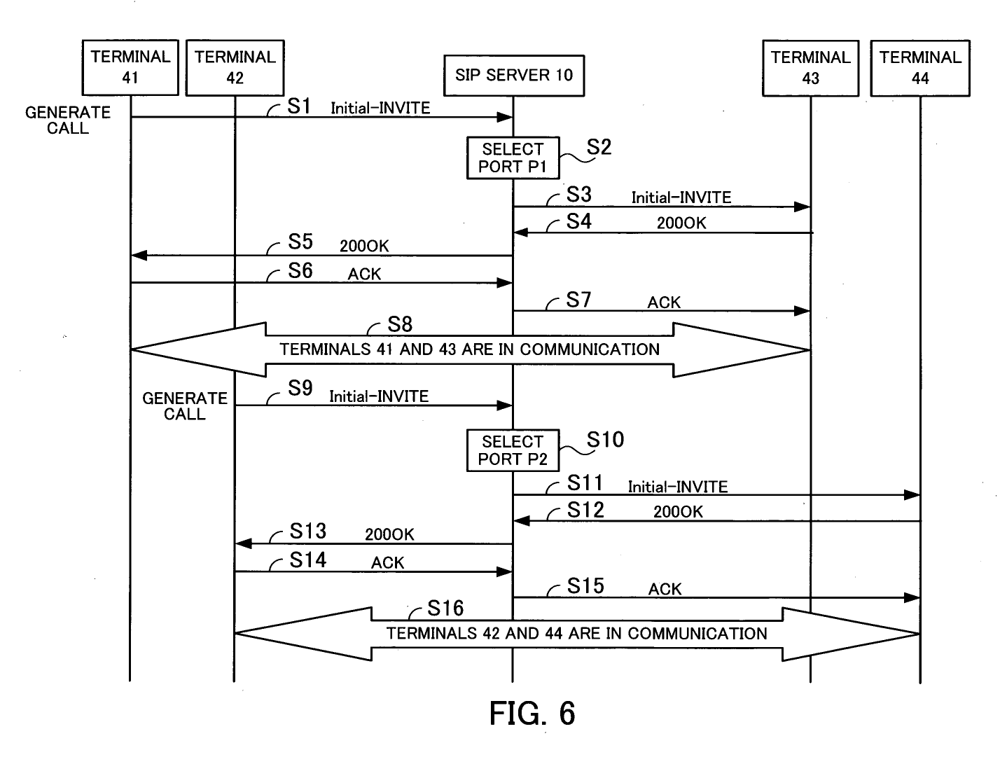

FIG. 6 is a sequence diagram showing the operations of the session establishment between the terminals. In the figure, a 100 Tyring message and a 180 Ringing message are omitted because of having no direct relation with this function.

[Step S1] The terminal 41 transmits an INVITE message to the SIP server 10 to initiate communication with the terminal 43. An INVITE message (call setting message) first transmitted to the SIP server 10 is referred to as an initial INVITE message.

[Step S2] The SIP server 10 receives, through the port P1 having a port number of 5060, the initial INVITE message transmitted from the terminal 41. The port P1 which receives the initial INVITE message is previously determined by default.

The SIP server 10 selects the port P1 as a port for performing subsequent communication between the terminals 41 and 43.

[Step S3] The SIP server 10 transmits to the terminal 43 the initial INVITE message received from the terminal 41.

[Step S4] The terminal 43, when receiving the initial INVITE message from the SIP server 10, transmits to the SIP server 10 a 200OK message to the INVITE message. At this time, the terminal 43 transmits the 200OK message to the port P1 of the SIP server 10.

[Step S5] The SIP server 10 transmits to the terminal 41 the 200OK message received through the port P1.

[Step S6] The terminal 41, when receiving the 200OK message from the terminal 43 through the SIP server 10, transmits an ACK message to the port P1 of the SIP server 10.

[Step S7] The SIP server 10 transmits to the terminal 43 the ACK message received through the port P1.

[Step S8] The terminals 41 and 43 establish a session therebetween and then initiate communication with each other.

[Step S9] The terminal 42 transmits an INVITE message to the SIP server 10 to initiate communication with the terminal 44. This INVITE message transmitted to the SIP server 10 by the terminal 42 is referred to as an initial INVITE message because of being a message first transmitted to the SIP server 10.

[Step S10] The SIP server 10 receives, through the port P2 having a port number of 5062, the initial INVITE message transmitted from the terminal 42. The port P2 which receives the initial INVITE message is previously determined by default.

The SIP server 10 selects the port P2 having a port number of 5062 as a port for performing subsequent communication between the terminals 42 and 44. The port P2 is selected in a round-robin fashion as described above. In step S2, the communication between the terminals 41 and 43 is allocated to the port P1 and therefore, the port P2 is selected for the communication between the terminals 42 and 44.

[Step S11] The SIP server 10 transmits to the terminal 44 the initial INVITE message received from the terminal 42.

[Step S12] The terminal 44, when receiving the initial INVITE message from the SIP server 10, transmits to the SIP server 10 a 200OK message to the INVITE message. At this time, the terminal 44 transmits the 200OK message to the port P2 of the SIP server 10.

[Step S13] The SIP server 10 transmits to the terminal 42 the 200OK message received through the port P2.

[Step S14] The terminal 42, when receiving the 200OK message from the terminal 44 through the SIP server 10, transmits an ACK message to the port P2 of the SIP server 10.

[Step S15] The SIP server 10 transmits to the terminal 44 the ACK message received through the port P2.

[Step S16] The terminals 42 and 44 establish a session therebetween and then initiate communication with each other.

The messages exchanged in the above-described steps will be described below.

First, the initial INVITE message transmitted to the SIP server 10 from the terminal 41 or 42 in step S1 or S9 will be described.

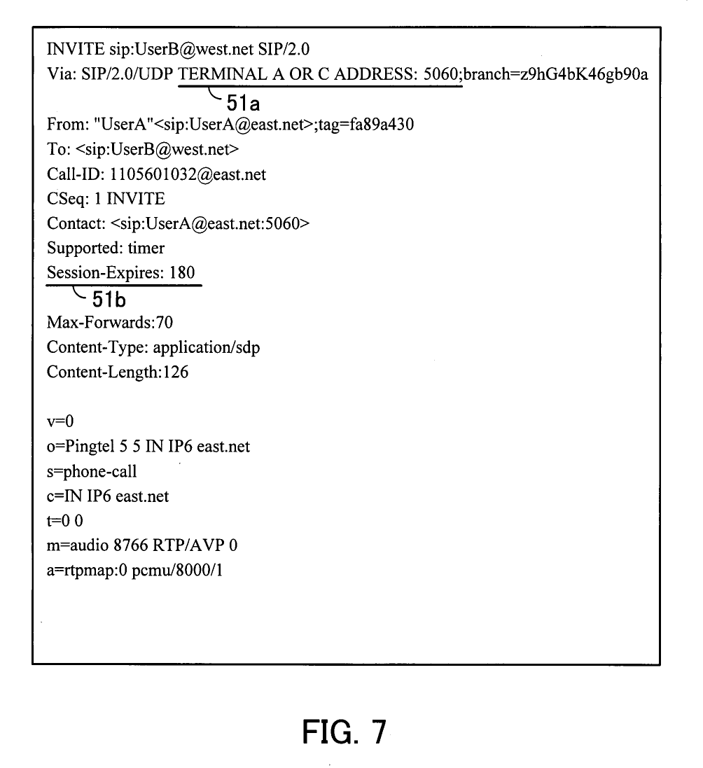

FIG. 7 shows an example of the initial INVITE message transmitted to the SIP server from the terminal. In a Via header of an underline 51a in the figure, routing information is set. More specifically, an address of the terminal as a transmission source of the initial INVITE message and a port number (5060) used by the terminal are set.

For example, when the initial INVITE message of the figure is a message transmitted from the terminal 41, an address A of the terminal 41 is set in the Via header of the underline 51a. When the initial INVITE message is a message transmitted from the terminal 42, an address C of the terminal 42 is set in the Via header of the underline 51a.

Further, a session timer is set in the initial INVITE message. In the example of the figure, 180 seconds as a session timer value is set in the Session-Expires header as shown by the underline 51b.

Next, the initial INVITE message transmitted to the terminal 43 or 44 from the SIP server 10 in step S3 or S11 will be described.

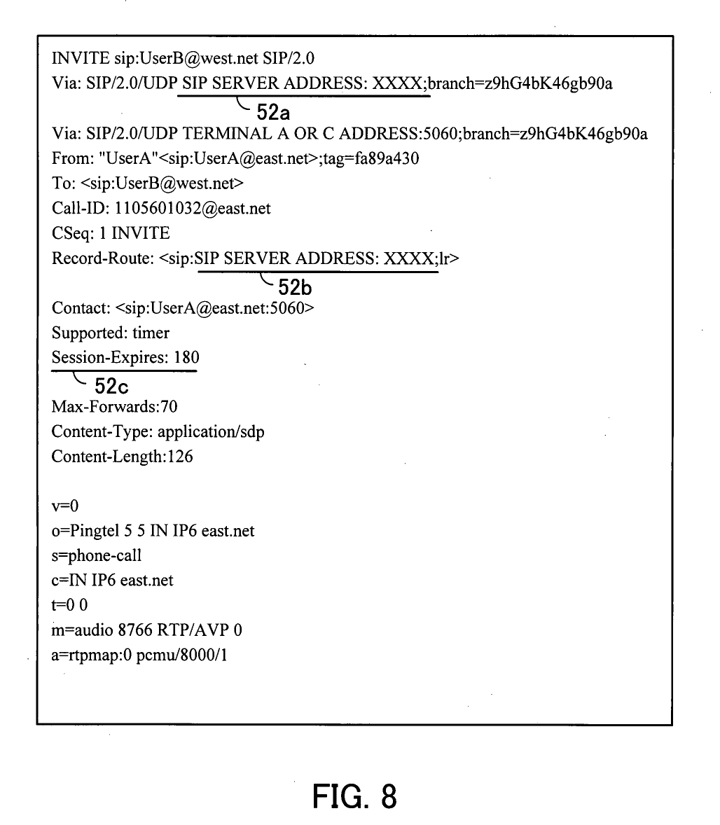

FIG. 8 shows an example of the initial INVITE message transmitted to the terminal from the SIP server. As shown by the underlines 52a and 52b of the figure, an IP address of the SIP server 10 and a port number selected by the SIP server 10 in a round-robin fashion are set in the Via header and the Record-Route header.

For example, in the case of the initial INVITE message transmitted in step S3, since the SIP server 10 selects the port P1 in step S2, the port number 5060 is set in the XXXX sections of the underlines 52a and 52b. In the case of the initial INVITE message transmitted in step S11, since the SIP server 10 selects the port P2 in step S10, the port number 5062 is set in the XXXX sections of the underlines 52a and 52b.

From the above information, the terminal 43 or 44 which receives the initial INVITE message knows to which port of the SIP server 10 to transmit the subsequent messages. For example, the terminal 43 knows to transmit the messages to the port P1 having the port number 5060 of the SIP server 10. The terminal 44 knows to transmit the messages to the port P2 having the port number 5062 of the SIP server 10.

Further, from the Session-Expires header of the underline 52c, the terminal 43 or 44 knows to set the session timer value to 180 seconds.

Next, the 200OK message transmitted to the SIP server 10 from the terminal 43 or 44 in step S4 or S12 will be described.

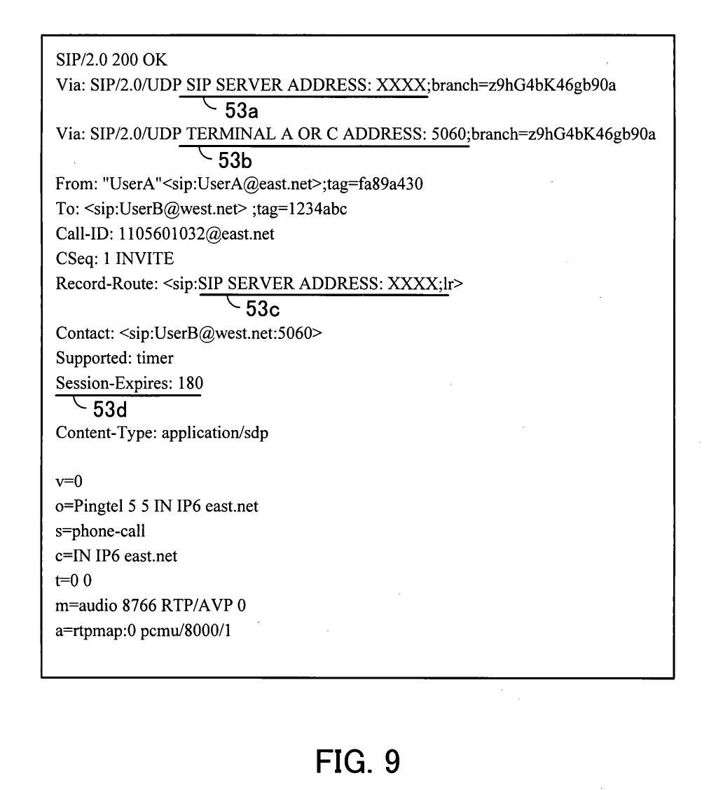

FIG. 9 shows an example of the 200OK message transmitted to the SIP server from the terminal. The Via headers and Record-Route header of the initial INVITE message received by the terminal 43 or 44 are copied to the Via headers shown by the underlines 53a and 53b, and to the Record-Route header shown by the underline 53c in the figure.

For example, in the case where the 200OK message shown in the figure is a message transmitted from the terminal 43, the address and port number 5060 of the SIP server 10 are copied to the Via header of the underline 53a as well as to the Record-Route header of the underline 53c. Further, the address A of the terminal 41 and the port number 5060 used by the terminal 41 are copied to the Via header of the underline 53b.

In the case where the 200OK message shown in the figure is a message transmitted from the terminal 44, the address and port number 5062 of the SIP server 10 are copied to the Via header of the underline 53a as well as to the Record-Route header of the underline 53c. Further, the address C of the terminal 42 and the port number 5062 used by the terminal 42 are copied to the Via header of the underline 53b.

Based on this information, the 200OK message transmitted from the terminal 43 is received through the port P1 of the SIP server 10, and the 200OK message transmitted from the terminal 44 is received through the port P2 of the SIP server 10.

In the Session-Expires header of the underline 53d in FIG. 9, 180 seconds is set as a session timer value.

Next, the 200OK message transmitted to the terminal 41 or 42 from the SIP server 10 in step S5 or S13 will be described.

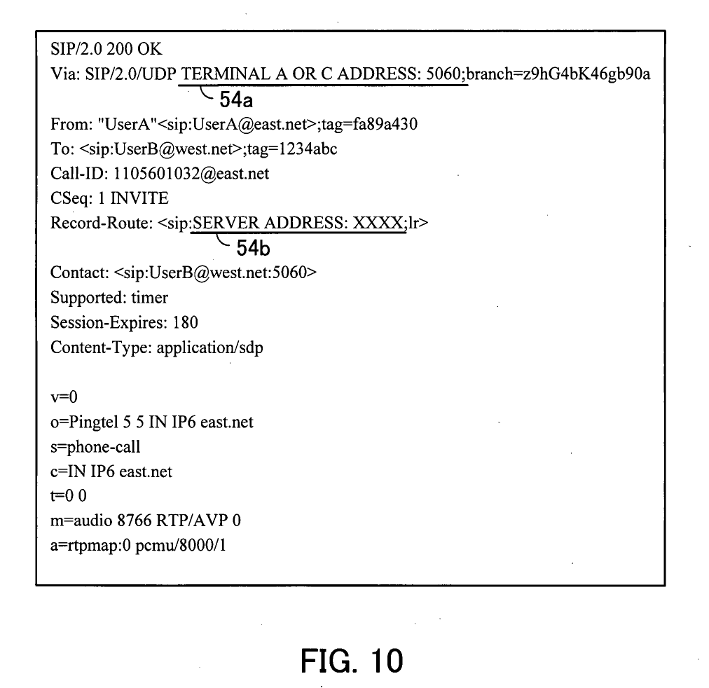

FIG. 10 shows an example of the 200OK message transmitted to the terminal from the SIP server. The SIP server 10 deletes the Via header at the head of the 200OK message received from the terminal 43 or 44, and transmits the result message to the terminal 41 or 42.

For example, the SIP server 10 deletes the Via header of the underline 53a in FIG. 9 to transmit the result 200OK message to the terminal 41 or 42. Accordingly, in the 200OK message transmitted to the terminal 41 or 42 from the SIP server 10, only the Via header which shows the address A or C of the terminal 41 or 42 as a destination of the 200OK message as well as the port number used by the terminal 41 or 42 remains as shown by the underline 54a in FIG. 10.

In the Record-Route header, the address of the SIP server 10 and the port number used are set as shown by the underline 54b. For example, when the SIP server 10 receives the 200OK message from the terminal 43 and transmits it to the terminal 41, the port number 5060 is set in the XXXX section of the underline 54b. When the SIP server 10 receives the 200OK message from the terminal 44 and transmits it to the terminal 42, the port number 5062 is set in the XXXX section of the underline 54b.

From the above information, the terminal 41 or 42 which receives the 200Ok message from the SIP server 10 knows to which port P1 or P2 of the SIP server 10 to transmit the subsequent messages. For example, from the Record-Route header of the received 200OK message, the terminal 41 knows to transmit the messages to the port P1 of the SIP server 10. From the Record-Route header of the received 200OK message, the terminal 42 knows to transmit the messages to the port P2 of the SIP server 10.

The terminal 41 or 42, when receiving the 200OK message from the terminal 43 or 44 through the SIP server 10, recognizes that negotiation of the session timer is completed. Then, the terminal 41 or 42 transmits the ACK message to the terminal 43 or 44.

Next, the ACK message transmitted to the SIP server 10 from the terminal 41 or 42 in step S6 or S14 will be described.

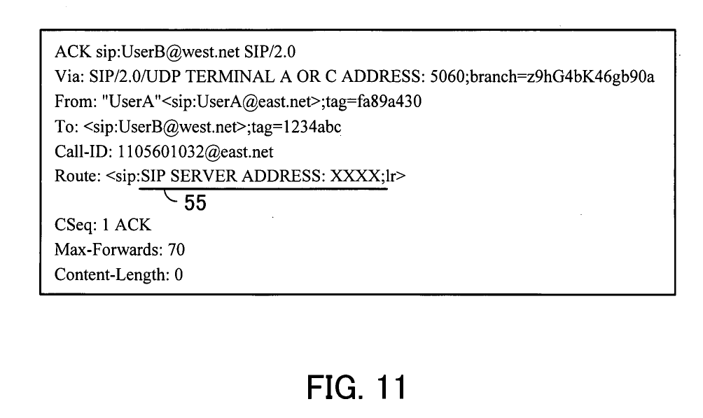

FIG. 11 shows an example of the ACK message transmitted to the SIP server from the terminal. In the Route header shown by the underline 55 in the figure, the same content as that of the Record-Route header of the 200OK message received from the SIP server 10 is set. In other words, the content of the Record-Route header shown by the underline 54b in FIG. 10 is set.

For example, in the case where the terminal 41 transmits the ACK message to the SIP server 10, the port number 5060 is set in the XXXX section of the Route header shown by the underline 55. In the case where the terminal 42 transmits the ACK message to the SIP server 10, the port number 5062 is set in the XXXX section of the Route header shown by the underline 55.

Based on this information, the ACK message transmitted by the terminal 41 or 42 is received by the port number of the SIP server 10 shown by the underline 55.

Next, the ACK message transmitted to the terminal 43 or 44 from the SIP server 10 in step S7 or S15 will be described.

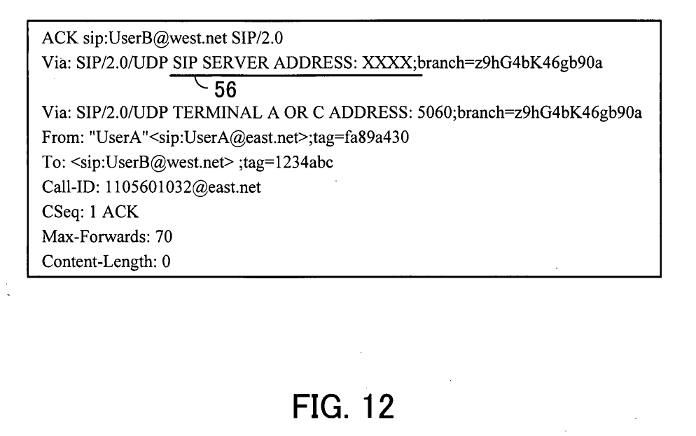

FIG. 12 shows an example of the ACK message transmitted to the terminal from the SIP server. The address and port number of the SIP server 10 which transmits the ACK message are set in the Via header shown by the underline 56 in the figure.

For example, in the case where the ACK message shown in the figure is a message for transferring the ACK message transmitted from the terminal 41, the port number 5060 is set in the XXXX section of the underline 56. In the case where the ACK message shown in FIG. 12 is a message for transferring the ACK message transmitted from the terminal 42, the port number 5062 is set in the XXXX section of the underline 56.

When the terminal 43 or 44 receives the ACK message, communication between the terminals 41 and 43 or between the terminals 42 and 44 is initiated.

Thus, the session is established between the terminals 41 to 44 through the SIP server 10 as well as the message transmission and reception between the terminals 41 to 44 is allocated to the ports P1 and P2 of the SIP server 10.

The terminal 43 or 44, in the wake of the transmission of the first 200OK message in step S4 or S12, sets a session timer to 170 seconds resulting from subtracting 10 seconds from 180 seconds. Further, the terminal 43 or 44, when receiving the refresh INVITE message from the terminal 41 or 42 in the next described existence check on the session between terminals during communication, updates the session timer.

At the same time, the terminal 41 or 42, in the wake of reception of the first 200OK message in step S5 or S13, sets a session timer to 170 seconds resulting from subtracting 10 seconds from 180 seconds. Further, the terminal 41 or 42 sets a refresh timer to 90 seconds which is half of 180 seconds. The terminal 41 or 42, in the wake of expiration of the refresh timer in the next described existence check on the session between terminals during communication, transmits the refresh INVITE message to the terminal 43 or 44. Then, the terminal 41 or 42, when receiving the 200Ok message to the refresh INVITE message from the terminal 43 or 44 before the session timer expires (before a time of 170 seconds passes), updates the session timer and the refresh timer.

Next, operations of the existence check on the session between the terminals 41 to 44 will be described.

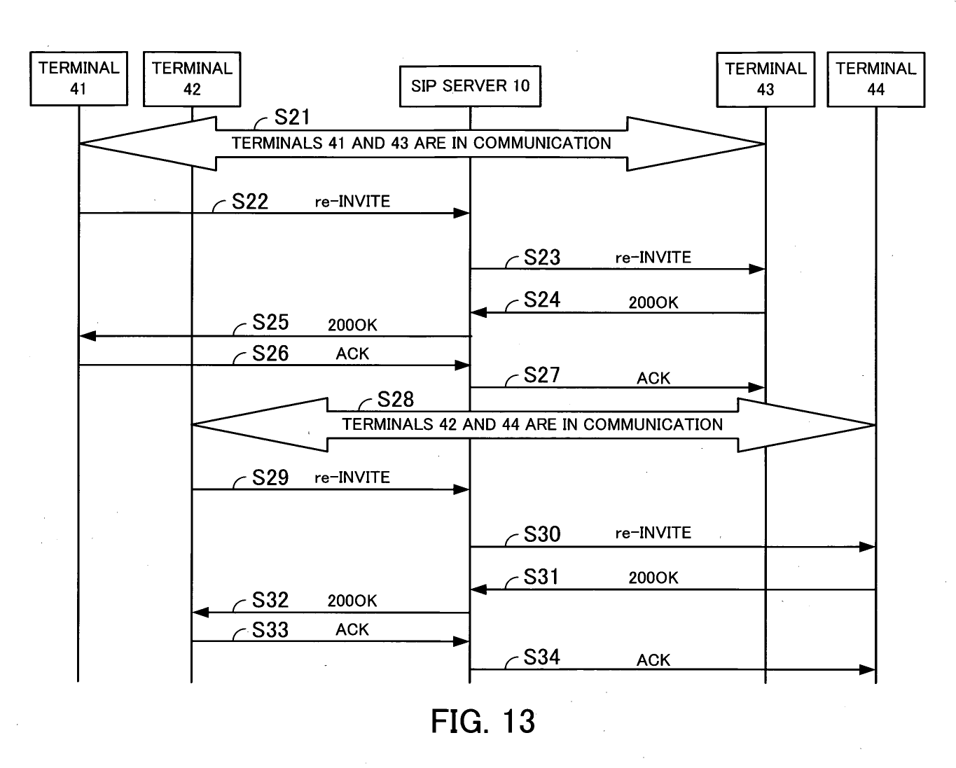

FIG. 13 is a sequence diagram showing the operations of the existence check on the session between the terminals. In the figure, the 100 Tyring message and the 180 Ringing message are omitted because of having no direct relation with this function.

[Step S21] Assume that the terminals 41 and 43 are in a communication state.

[Step S22] The terminal 41, when the refresh timer which is set to 90 seconds expires during communication, transmits the refresh INVITE message to the SIP server 10. At this time, the terminal 41 transmits the refresh INVITE message to the port P1 of the SIP server 10.

[Step S23] The SIP server 10 transmits to the terminal 43 the refresh INVITE message received from the terminal 41.

[Step S24] The terminal 43, when receiving the refresh INVITE message from the terminal 41 through the SIP server 10, transmits the 200OK message to the port P1 of the SIP server 10.

The terminal 43, in the wake of the transmission of the 200OK message to the refresh INVITE message of the terminal 41, updates the session timer (170 seconds). The terminal 43, when receiving no refresh INVITE message from the terminal 41 before the session timer expires, interrupts the session.

[Step S25] The SIP server 10 transmits to the terminal 41 the 200OK message received from the terminal 43.

[Step S26] The terminal 41, when receiving the 200OK message from the SIP server 10, transmits the ACK message to the port P1 of the SIP server 10.

The terminal 41, in the wake of the reception of the 200OK message from the terminal 43, updates the session timer (170 seconds) and the refresh timer (90 seconds). The terminal 41, when receiving no 200OK message from the terminal 43 before the session timer expires, interrupts the session.

[Step S27] The SIP server 10 transmits to the terminal 43 the ACK message received from the terminal 41.

Subsequently, the same operation as described above is repeated. Specifically, the terminal 41, when the refresh timer (90 seconds) expires, transmits the refreshing INVITE message to the terminal 43. The terminal 43, when receiving the refreshing INVITE message from the terminal 41, transmits the 200OK message to the terminal 41. The terminal 43, in the wake of the transmission of the 200OK message to the refresh INVITE message of the terminal 41, updates the session timer. The terminal 41, in the wake of the reception of the 200OK message from the terminal 43, updates the session timer (170 seconds) and the refresh timer (90 seconds).

[Step S28] Assume that the terminals 42 and 44 are in a communication state.

[Step S29] The terminal 42, when the refresh timer which is set to 90 seconds expires during communication, transmits the refresh INVITE message to the SIP server 10. At this time, the terminal 42 transmits the refresh INVITE message to the port P2 of the SIP server 10.

[Step S30] The SIP server 10 transmits to the terminal 44 the refresh INVITE message received from the terminal 42.

[Step S31] The terminal 44, when receiving the refresh INVITE message from the terminal 42 through the SIP server 10, transmits the 200OK message to the port P2 of the SIP server 10.

The terminal 44, in the wake of the transmission of the 200OK message to the refresh INVITE message of the terminal 42, updates the session timer (170 seconds). The terminal 44, when receiving no refresh INVITE message from the terminal 42 before the session timer expires, interrupts the session.

[Step S32] The SIP server 10 transmits to the terminal 42 the 200OK message received from the terminal 44.

[Step S33] The terminal 42, when receiving the 200OK message from the SIP server 10, transmits the ACK message to the port P2 of the SIP server 10.

The terminal 42, in the wake of the reception of the 200OK message from the terminal 44, updates the session timer (170 seconds) and the refresh timer (90 seconds) The terminal 42, when receiving no 200OK message from the terminal 44 before the session timer expires, interrupts the session.

[Step S34] The SIP server 10 transmits to the terminal 44 the ACK message received from the terminal 42.

Subsequently, the same operation as described above is repeated. Specifically, the terminal 42, when the refresh timer (90 seconds) expires, transmits the refresh INVITE message to the terminal 44. The terminal 44, when receiving the refresh INVITE message from the terminal 42, transmits the 200OK message to the terminal 42. The terminal 44, in the wake of the transmission of the 200OK message to the refresh INVITE message of the terminal 42, updates the session timer. The terminal 42, in the wake of the reception of the 200OK message from the terminal 44, updates the session timer (170 seconds) and the refresh timer (90 seconds).

The messages exchanged in the above-described steps will be described below.

First, the refresh INVITE message transmitted to the SIP server 10 from the terminal 41 or 42 in step S22 or S29 will be described.

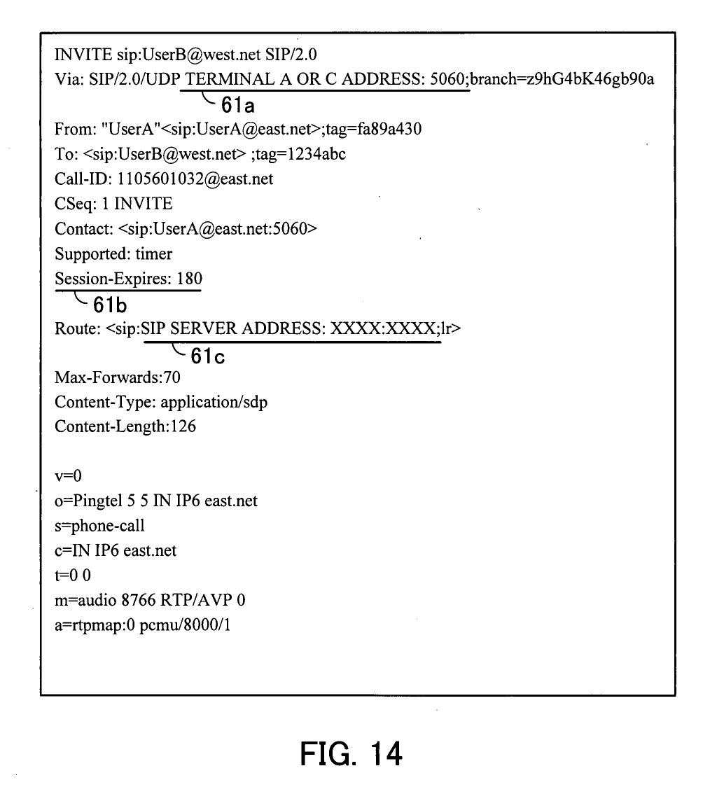

FIG. 14 shows an example of the refresh INVITE message transmitted to the SIP server from the terminal. In the Via header of an underline 61a in the figure, routing information is set. More specifically, an address of the terminal as a transmission source of the refresh INVITE message and a port number (5060) used by the terminal are set.

For example, when the refresh INVITE message of the figure is a message transmitted from the terminal 41, an address A of the terminal 41 is set in the Via header of the underline 61a. When the refresh INVITE message is a message transmitted from the terminal 42, an address C of the terminal 42 is set in the Via header of the underline 61a.

Further, a session timer is set in the refresh INVITE message. In the example of the figure, 180 seconds as a session timer value is set in the Session-Expires header as shown by the underline 61b.

Further, the same content as that of the Route header shown by the underline 55 in FIG. 11 is set in the Route header shown by the underline 61c.

Accordingly, in the case where the refresh INVITE message of the figure is a message transmitted from the terminal 41, the port number 5060 of the port P1 of the SIP server 10 is set in the XXXX section of the underline 61c. In the case where the refresh INVITE message is a message transmitted from the terminal 42, the port number 5062 of the port P2 of the SIP server 10 is set in the XXXX section of the underline 61c. Based on this information, the refresh INVITE message is received through the predetermined port P1 or P2 of the SIP server 10.

Next, the refresh INVITE message transmitted to the terminal 43 or 44 from the SIP server 10 in step S23 or S30 will be described.

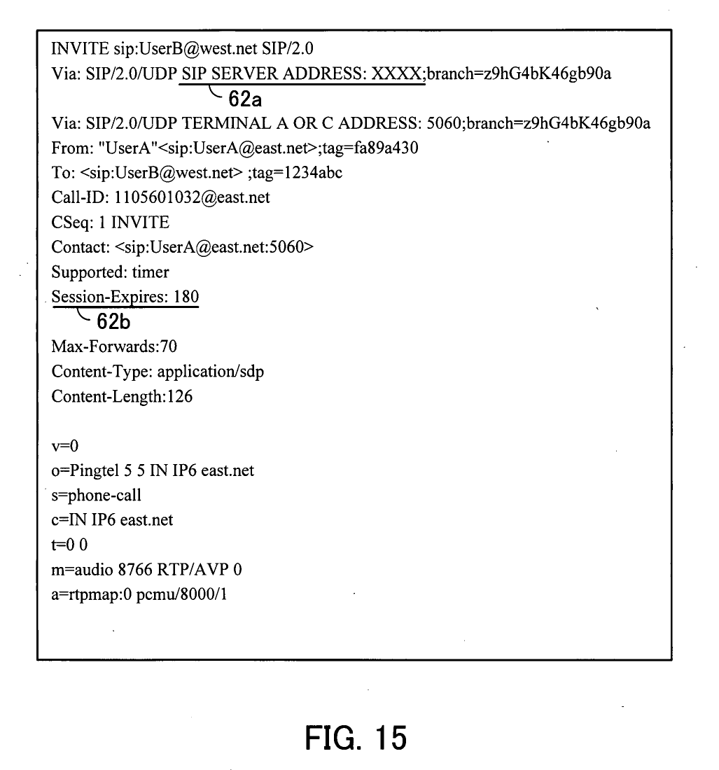

FIG. 15 shows an example of the refresh INVITE message transmitted to the terminal from the SIP server. The IP address of the SIP server 10 and the number of the port which receives the refresh INVITE message from the terminal 41 or 42 are set in the Via header shown by the underline 62a in the figure.

For example, in the case of receiving the refresh INVITE message from the terminal 41, the SIP server 10 receives this message by the port number 5060. Accordingly, in this case, the port number 5060 is set in the XXXX section of the underline 62a. In the case of receiving the refreshing INVITE message from the terminal 42, the SIP server 10 receives this message by the port number 5062. Accordingly, in this case, the port number 5062 is set in the XXXX section of the underline 62a.

Further, from the Session-Expires header of the underline 62b, the terminal 43 or 44 knows to update the session timer in 180 seconds.

Next, the 200OK message transmitted to the SIP server 10 from the terminal 43 or 44 in step S24 or S31 will be described.

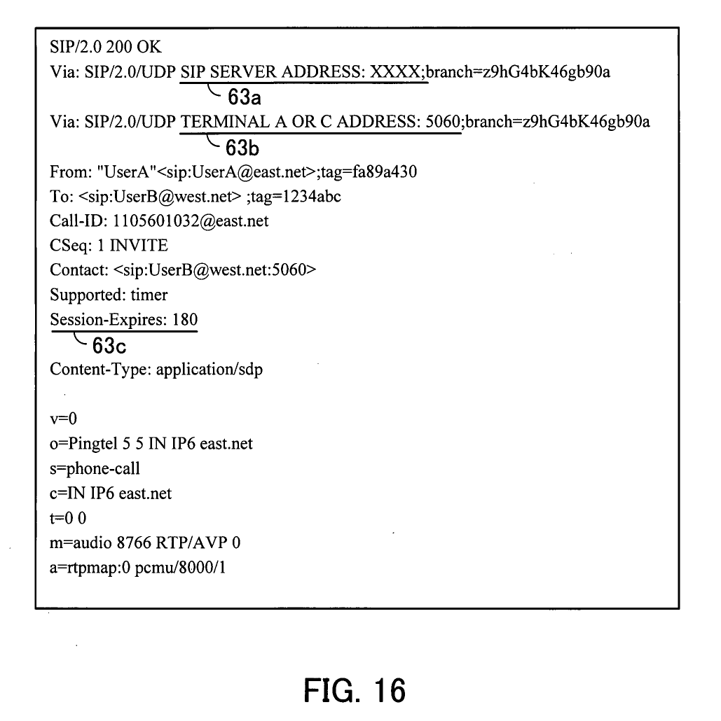

FIG. 16 shows an example of the 200OK message transmitted to the SIP server from the terminal. The Via headers of the refresh INVITE message received by the terminal 43 or 44 are copied to the Via headers shown by the underlines 63a and 63b in the figure.

For example, in the case where the 200OK message shown in the figure is a message transmitted from the terminal 43, the address and port number 5060 of the SIP server 10 are copied to the Via header of the underline 63a. Further, the address A of the terminal 41 and the port number 5060 used by the terminal 41 are copied to the Via header of the underline 63b. In the case where the 200OK message shown in the figure is a message transmitted from the terminal 44, the address and port number 5062 of the SIP server 10 are copied to the Via header of the underline 63a. Further, the address C of the terminal 42 and the port number 5062 used by the terminal 42 are copied to the Via header of the underline 63b.

Based on this information, the 200OK message transmitted from the terminal 43 is received through the port P1 of the SIP server 10, and the 200OK message transmitted from the terminal 44 is received through the port P2 of the SIP server 10.

In the Session-Expires header of the underline 63c in FIG. 16, 180 seconds is set as a session timer value.

Next, the 200OK message transmitted to the terminal 41 or 42 from the SIP server 10 in step S25 or S32 will be described.

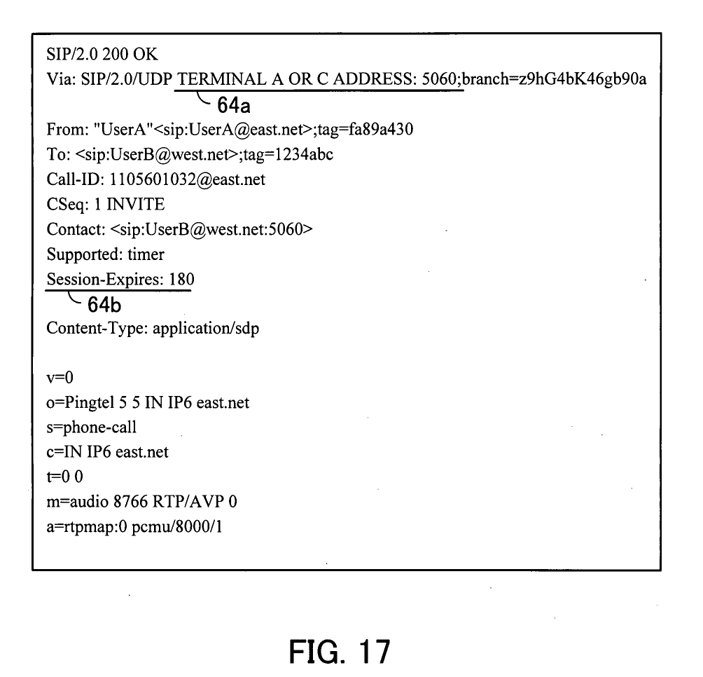

FIG. 17 shows an example of the 200OK message transmitted to the terminal from the SIP server. The SIP server 10 deletes the Via header at the head of the 200OK message received from the terminal 43 or 44, and transmits the result message to the terminal 41 or 42.

For example, the SIP server 10 deletes the Via header of the underline 63a in FIG. 16 to transmit the result 200OK message to the terminal 41 or 42. Accordingly, in the 200OK message transmitted to the terminal 41 or 42 from the SIP server 10, only the Via header which shows the address A or C of the terminal 41 or 42 as a destination of the 200OK message as well as the port number used by the terminal 41 or 42 remains as shown by the underline 64a in FIG. 17.

Thus, the 200OK message transmitted from the SIP server 10 is received by the terminal 41 or 42.

The terminal 41 or 42, in the wake of the reception of the first 200OK message, updates the session timer and the refresh timer. For example, from 180 seconds of the Session-Expires header shown by the underline 64b, the terminal 41 or 42 sets the session timer to 170 seconds resulting from subtracting 10 seconds from 180 seconds as well as sets the refresh timer to 90 seconds which is half of 180 seconds.

Next, the ACK message transmitted to the SIP server 10 from the terminal 41 or 42 in step S26 or S33 will be described.

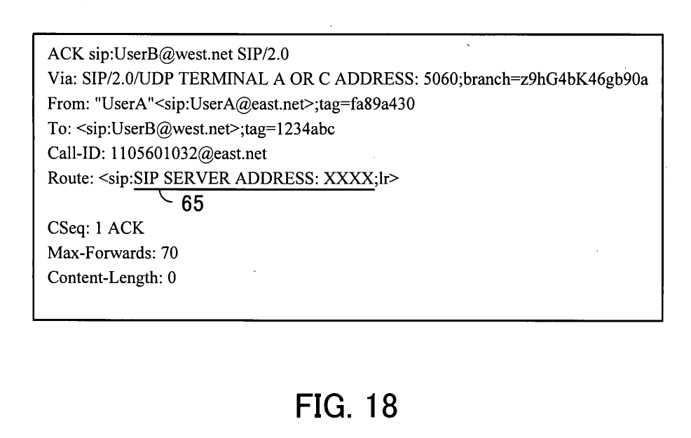

FIG. 18 shows an example of the ACK message transmitted to the SIP server from the terminal. In the Route header shown by the underline 65 in the figure, the same content as that of the Route header of the underline 55 in FIG. 11 is set.

Accordingly, in the case where the ACK message in the figure is a message transmitted from the terminal 41, the port number 5060 of the port P1 of the SIP server 10 is set in the XXXX section of the underline 65. In the case where the ACK message in the figure is a message transmitted from the terminal 42, the port number 5062 of the port P2 of the SIP server 10 is set in the XXXX section of the underline 65.

Based on this information, the ACK message transmitted from the terminal 41 or 42 is received by the port number of the SIP server 10 shown by the underline 65.

Next, the ACK message transmitted to the terminal 43 or 44 from the SIP server 10 in step S27 or S34 will be described.

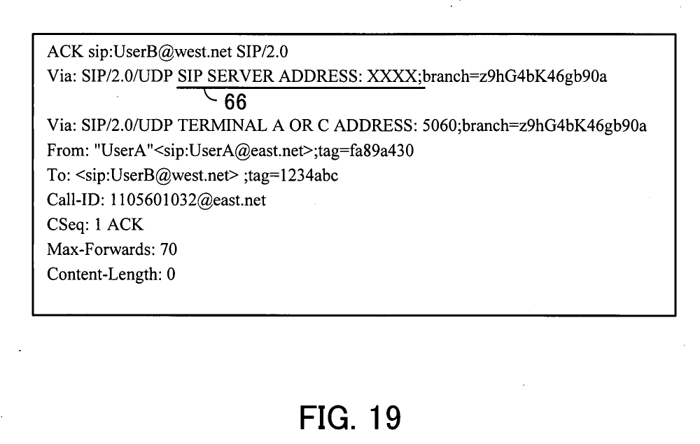

FIG. 19 shows an example of the ACK message transmitted to the terminal from the SIP server. The address and port number of the SIP server 10 which transmits the ACK message are set in the Via header shown by the underline 66 in the figure.

For example, in the case where the ACK message shown in the figure is a message for transferring the ACK message transmitted from the terminal 41, the port number 5060 is set in the XXXX section of the underline 66. In the case where the ACK message shown in the figure is a message for transferring the ACK message transmitted from the terminal 42, the port number 5062 is set in the XXXX section of the underline 66.

When the terminal 43 or 44 receives the ACK message, refresh operations between the terminals 41 and 43 or between the terminals 42 and 44 are completed.

Thus, the existence check on the session between the terminals 41 to 44 is performed.

As described above, the CPUs 10a and 10b are provided with the ports P1 and P2, respectively. Further, messages transmitted and received between the terminals 41 to 44 after the call setting message are allocated to the ports P1 and P2 in a round-robin fashion. As a result, the message transmission and reception between the terminals 41 to 44 is evenly distributed to the CPUs 10a and 10b, so that the overloaded state of the SIP server 10 can be reduced.

Further, when the overloaded state of the SIP server 10 is reduced, a state incapable of receiving a refreshing message is suppressed. Therefore, a state of erroneously opening a session is reduced.

Next, a second embodiment according to the present invention will be described in detail with reference to the accompanying drawings. In the first embodiment, the port is sorted in a round-robin fashion. In the second embodiment, the port is sorted based on the message reception amount per unit time. Specifically, the port selection in steps S2 and S10 shown in FIG. 6 is made not in a round-robin fashion but based on the message reception amount per unit time.

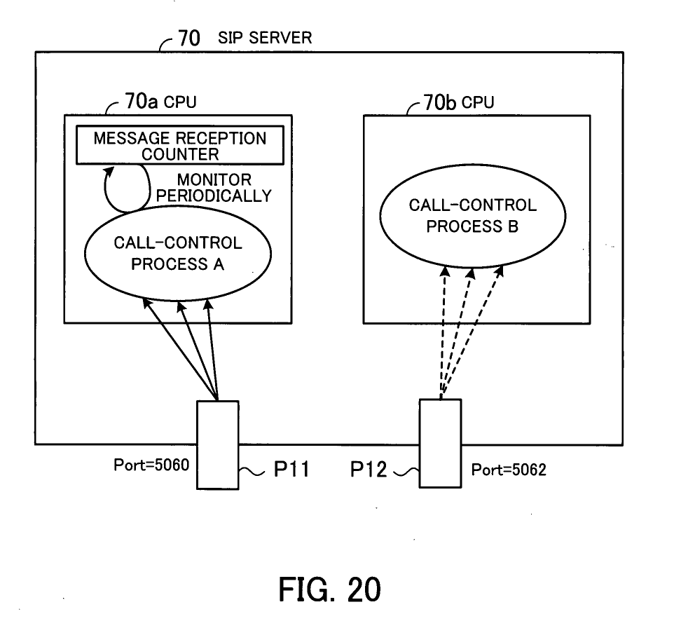

FIG. 20 illustrates port allocation in the SIP server according to the second embodiment. As shown in the figure, a SIP server 70 has CPUs 70a and 70b.

Call-control processes A and B are allocated to the CPUs 70a and 70b, respectively. Each of the call-control processes A and B opens a socket for the port.

For example, the call-control process A opens a socket for a port P11 (port number: 5060) and the call-control process B opens a socket for a port P12 (port number: 5062). Thus, the ports P11 and P12 are allocated to the CPUs 70a and 70b, respectively.

The CPU 70a periodically obtains from a message reception counter the message reception amount per unit time. The CPU 70a, when the message reception amount per unit time exceeds the threshold, controls such that the message exchange between a terminal which generates a call and a terminal as a communication partner is allocated to the CPU 70b (port P12). More specifically, the CPU 70a, when the message reception amount per unit time exceeds the threshold, controls such that a call processing is performed by the CPU 70b (call-control process B).

On the other hand, the CPU 70a, by performing the port distribution (sorting of the messages to the CPU 70b), decreases in the message reception amount per unit time. Accordingly, the CPU 70a, when the message reception amount per unit time is less than the threshold, stops the port distribution. The threshold for starting the port distribution and that for stopping the port distribution may be different.

For example, when a maximum throughput of each of the CPUs 70a and 70b is a hundred thousand BHC (BHC: Busy Hour Call), the maximum amount of messages processable per second is about 27 msg/sec. Accordingly, the threshold for starting the port distribution is set to, for example, 20 msg/sec which is 70% of 27 msg/sec. Further, the threshold for stopping the port distribution is set to, for example, 16 msg/sec which is 60% of 27 msg/sec.

The CPU 70a periodically monitors the message reception counter. In the case where the message reception amount is less than 20 msg/sec, the CPU 70a allocates to the port P11 a call from the terminal. In the case where the message reception amount exceeds 20 msg/sec, the CPU 70a allocates to the port P12 a call from the terminal.

When the port distribution is performed, the amount of messages received through the port P11 decreases. The CPU 70a, when a value of the message reception counter is less than 16 msg/sec which is the threshold for stopping the port distribution, stops the sorting of messages to the port P12.

FIG. 20 shows a distribution configuration using two CPUs. Further, the number of CPUs used may be three or more.

Next, a function of the SIP server 70 will be described.

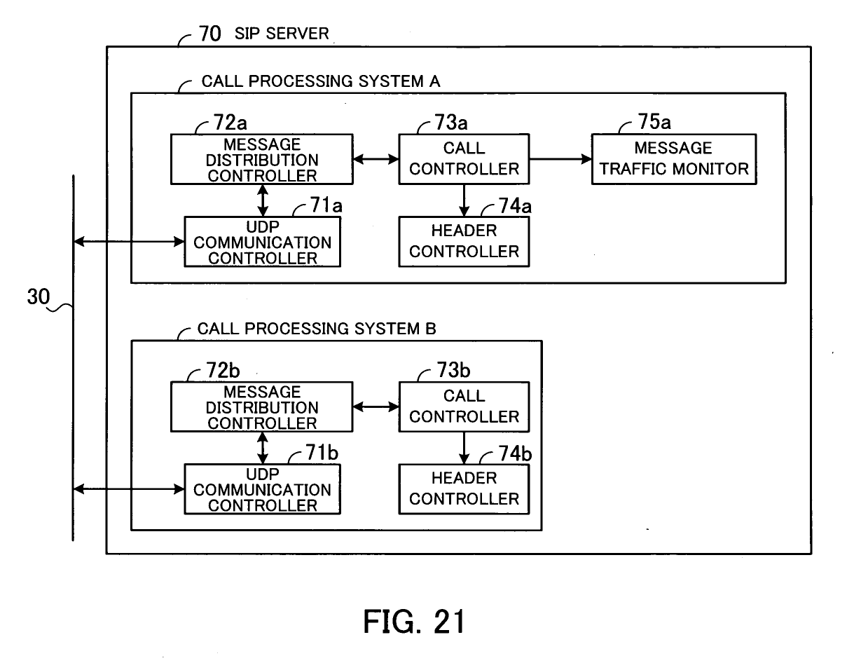

FIG. 21 is a functional block diagram of the SIP server. As shown in the figure, the function of the SIP server 70 is divided into that of a call processing system A and that of a call processing system B. The function of the call processing system A is realized by the CPU 70a shown in FIG. 20 and the function of the call processing system B is realized by the CPU 70b shown in FIG. 20. FIG. 21 also shows the IP network 30 shown in FIG. 2.

The call processing system A has a UDP communication controller 71a, a message distribution controller 72a, a call controller 73a, a header controller 74a and a message traffic monitor 75a. The call processing system B has a UDP communication controller 71b, a message distribution controller 72b, a call controller 73b and a header controller 74b.

The UDP communication controllers 71a and 71b manage the ports P11 and P12 as well as control the transmission and reception of UDP signals.

The message distribution controllers 72a and 72b analyze the received UDP signal and determine whether the UDP signal is a signal to be received by themselves. The message distribution controllers 72a and 72b, when the UDP signal is a signal to be received by themselves, output the signal to the call controllers 73a and 73b.

The call controllers 73a and 73b perform a call processing based on the SIP. Further, the call controller 73a periodically obtains the message reception amount per unit time from the message traffic monitor 75a. Then, the controller 73a compares the message reception amount obtained and the threshold to determine whether to receive the message through the other UDP port. The controller 73a, when determining to receive the message through the other port, issues an instruction to the header controller 74a to allow the message to be received through the other port.

The header controllers 74a and 74b perform a header control corresponding to the SIP by the header generation and editing instructions from the call controllers 73a and 73b.

The message traffic monitor 75a generates the message reception counter value shown in FIG. 20 and calculates the message reception amount per unit time.

Next, the port distribution in the SIP server 70 will be described.

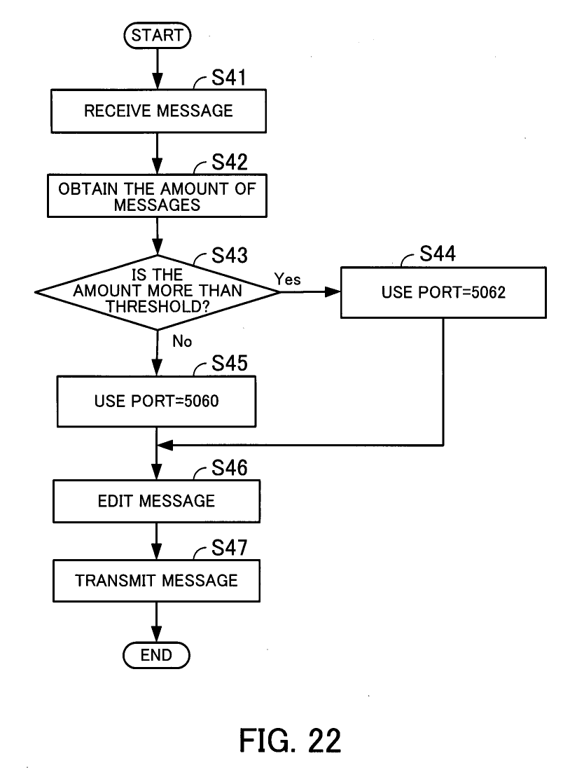

FIG. 22 is a flowchart showing operations of the port distribution in the SIP server.

[Step S41] The CPU 70a of the SIP server 70 receives the initial INVITE message through the port P11.

[Step S42] The CPU 70a of the SIP server 70 obtains the message reception amount per unit time from the message reception counter.

[Step S43] The CPU 70a of the SIP server 70 determines whether the message reception amount per unit time is more than the threshold. When the message reception amount is more than the threshold, the CPU 70a goes to step S44. When the message reception amount is less than the threshold, the CPU 70a goes to step S45.

[Step S44] The CPU 70a of the SIP server 70 determines the use of the port P12 with the port number 5062.

[Step S45] The CPU 70a of the SIP server 70 determines the use of the port P11 with the port number 5060.

[Step S46] The CPU 70a of the SIP server 70, when going through step S44, performs editing of the initial INVITE message such that the subsequent message exchange between terminals is performed through the port P12. The CPU 70a of the SIP server 70, when going through step S45, performs editing of the initial INVITE message such that the subsequent message exchange between terminals is performed through the port P11. The editing processing of the initial INVITE message includes, for example, editing of the Via header and the Record-Route header.

[Step S47] The CPU 70a of the SIP server 70 transmits to the terminal the edited initial INVITE message.

When the CPUs 70a and 70b for transmitting and receiving messages are thus sorted based on the message reception amount per unit time, an overloaded state of the SIP server 70 can be reduced.

Next, a third embodiment according to the present invention will be described in detail with reference to the accompanying drawings. In the first embodiment, the port is sorted in a round-robin fashion. In the third embodiment, the port is sorted based on the usage rate of the CPU. Specifically, the port selection in steps S2 and S10 shown in FIG. 6 is made not in a round-robin fashion but based on the usage rate of the CPU.

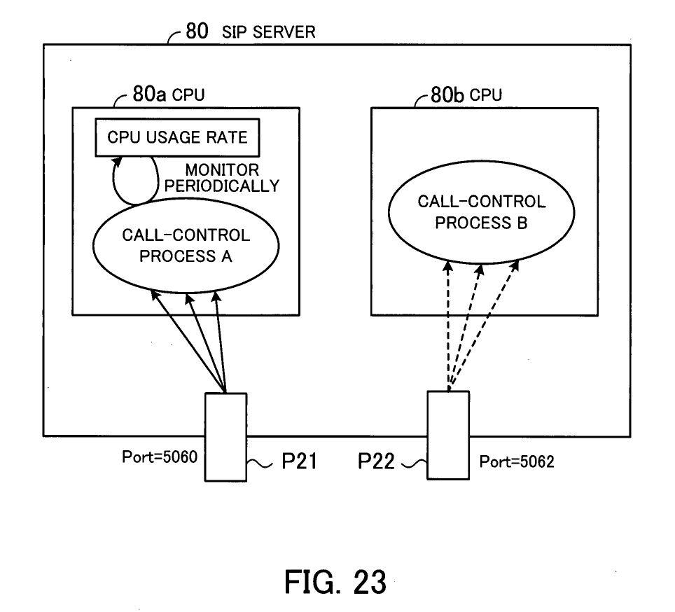

FIG. 23 illustrates port allocation in the SIP server according to the third embodiment. As shown in the figure, a SIP server 80 has CPUs 80a and 80b.

Call-control processes A and B are allocated to the CPUs 80a and 80b, respectively. Each of the call-control processes A and B opens a socket for the port.

For example, the call-control process A opens a socket for a port P21 (port number: 5060) and the call-control process B opens a socket for a port P22 (port number: 5062). Thus, the ports P21 and P22 are allocated to the CPUs 80a and 80b, respectively.

The CPU 80a periodically obtains its own CPU usage rate. The CPU 80a, when the CPU usage rate exceeds the threshold, controls such that the message exchange between the terminal which generates a call and a terminal as a communication partner is allocated to the CPU 80b (port P22). More specifically, the CPU 80a, when the CPU usage rate exceeds the threshold, controls such that a call processing is performed by the CPU 80b (call-control process B).

On the other hand, the CPU 80a, by performing the port distribution (sorting of the messages to the CPU 80b), decreases in the CPU usage rate. Accordingly, the CPU 80a, when the CPU usage rate is less than the threshold, stops the port distribution. The threshold for starting the port distribution and that for stopping the port distribution may be different.

For example, when the usage rate of each of the CPUs 80a and 80b in the maximum call processing load is 100%, the threshold for starting the port distribution is set to, for example, 70% of the maximum call processing load. Further, the threshold for stopping the port distribution is set to, for example, 50% of the maximum call processing load.

The CPU 80a periodically (e.g., at every five minutes) obtains the CPU usage rate. In the case where the usage rate is less than 70%, the CPU 80a allocates to the port P21 a call from the terminal. In the case where the usage rate exceeds 70%, the CPU 80a allocates to the port P22 a call from the terminal.

When the port distribution is performed, the amount of messages received through the port P21 decreases and as a result, the usage rate of the CPU 80a decreases. The CPU 80a, when the CPU usage rate is less than 50%, stops the sorting of messages to the port P22.

FIG. 23 shows a distribution configuration using two CPUs. Further, the number of CPUs used may be three or more.

Next, a function of the SIP server 80 will be described.

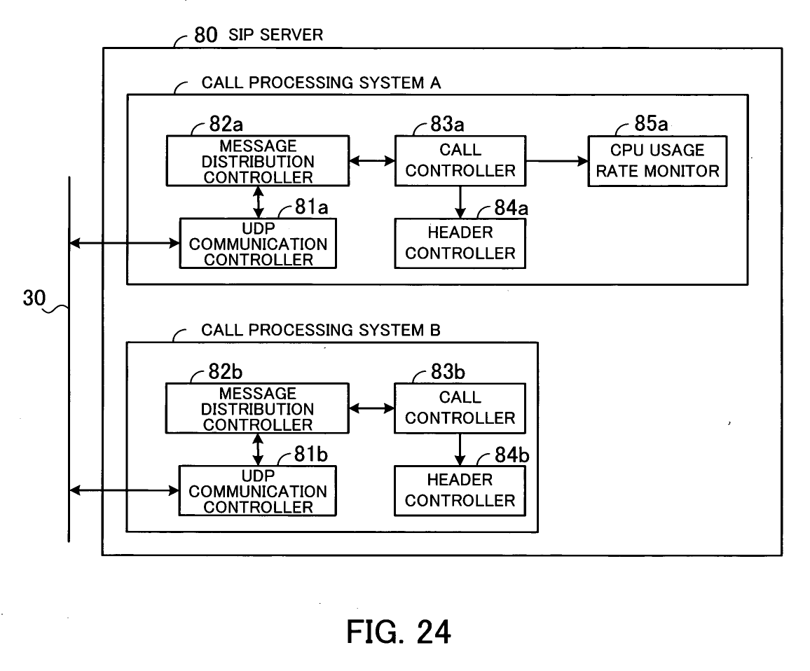

FIG. 24 is a functional block diagram of the SIP server. As shown in the figure, the function of the SIP server 80 is divided into that of a call processing system A and that of a call processing system B. The function of the call processing system A is realized by the CPU 80a shown in FIG. 23 and the function of the call processing system B is realized by the CPU 80b shown in FIG. 23. FIG. 24 also shows the IP network 30 shown in FIG. 2.

The call processing system A has a UDP communication controller 81a, a message distribution controller 82a, a call controller 83a, a header controller 84a and a CPU usage rate monitor 85a. The call processing system B has a UDP communication controller 81b, a message distribution controller 82b, a call controller 83b and a header controller 84b.

The UDP communication controllers 81a and 81b manage the ports P21 and P22 as well as control the transmission and reception of UDP signals.

The message distribution controllers 82a and 82b analyze the received UDP signal and determine whether the UDP signal is a signal to be received by themselves. The message distribution controllers 82a and 82b, when the UDP signal is a signal to be received by themselves, output the signal to the call controllers 83a and 83b.

The call controllers 83a and 83b perform a call processing based on the SIP. Further, the call controller 83a periodically obtains the usage rate of the CPU 80a from the CPU usage rate monitor 85a. Then, the controller 83a compares the obtained usage rate and the threshold to determine whether to receive the message through the other UDP port. The controller 83a, when determining to receive the message through the other port, issues an instruction to the header controller 84a to allow the message to be received through the other port.

The header controllers 84a and 84b perform a header control corresponding to the SIP by the header generation and editing instructions from the call controllers 83a and 83b.

The CPU usage rate monitor 85a detects the usage rate of the CPU 80a. The monitor 85a corresponds to the CPU usage rate in FIG. 23.

Next, the port distribution in the SIP server 80 will be described.

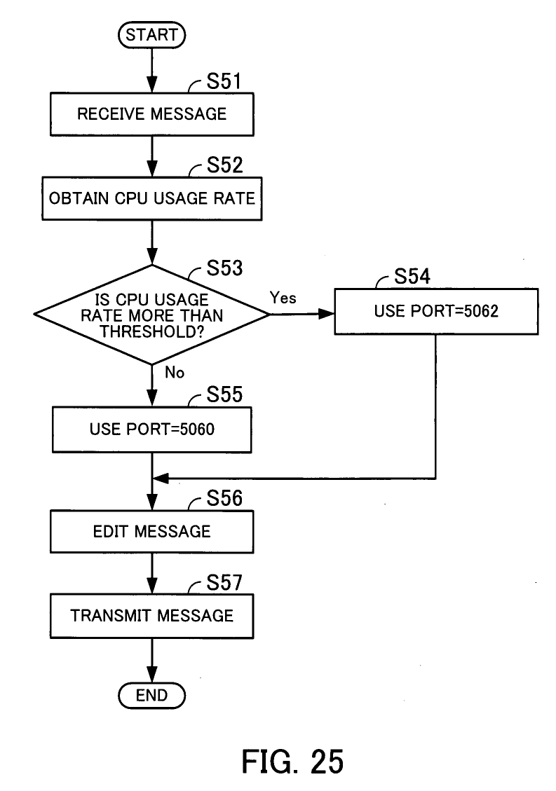

FIG. 25 is a flowchart showing operations of the port distribution in the SIP server.

[Step S51] The CPU 80a of the SIP server 80 receives the initial INVITE message through the port P21.

[Step S52] The CPU 80a of the SIP server 80 obtains the CPU usage rate.

[Step S53] The CPU 80a of the SIP server 80 determines whether the CPU usage rate is more than the threshold. When the CPU usage rate is more than the threshold, the CPU 80a goes to step S54. When the CPU usage rate is less than the threshold, the CPU 80a goes to step S55.

[Step S54] The CPU 80a of the SIP server 80 determines the use of the port P22 with the port number 5062.

[Step S55] The CPU 80a of the SIP server 80 determines the use of the port P21 with the port number 5060.

[Step S56] The CPU 80a of the SIP server 80, when going through step S54, performs editing of the initial INVITE message such that the subsequent message exchange between terminals is performed through the port P22. The CPU 80a of the SIP server 80, when going through step S55, performs editing of the initial INVITE message such that the subsequent message exchange between terminals is performed through the port P21. The editing processing of the initial INVITE message includes, for example, editing of the Via header and the Record-Route header.

[Step S57] The CPU 80a of the SIP server 80 transmits to the terminal the edited initial INVITE message.

When the CPUs 80a and 80b for transmitting and receiving messages are thus sorted based on the usage rate of the CPU 80a, an overloaded state of the SIP server 80 can be reduced.

The server of the present invention comprises a central processing unit for receiving a first message transmitted from a terminal to establish the session and for allocating, to itself and the other plural central processing units, subsequent message transmission and reception between the terminal and a terminal as a communication partner. As a result, the message transmission and reception between terminals is distributed to the central processing unit and the other central processing units, and therefore the overloaded state of the server can be reduced even if messages are frequently generated.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A server for establishing and maintaining a session between terminals, comprising:
a central processing unit for receiving a first message transmitted from a terminal to establish the session and for allocating, to one of the central processing unit and other plural central processing units, subsequent message transmission and reception between the terminal and a terminal as a communication partner.

2. The server according to claim 1, wherein:
the central processing unit allocates the message transmission and reception in a round-robin fashion.

3. The server according to claim 1, wherein:
the central processing unit allocates the message transmission and reception based on a reception amount of the message per unit time.

4. The server according to claim 3, wherein:
the central processing unit, when the reception amount is less than a threshold, allocates to the central processing unit the message transmission and reception.

5. The server according to claim 3, wherein:
the central processing unit, when the reception amount exceeds a threshold, allocates the message transmission and reception to one of the other plural central processing units.

6. The server according to claim 1, wherein:
the central processing unit allocates the message transmission and reception based on its own usage rate.

7. The server according to claim 6, wherein:
the central processing unit, when the usage rate is less than a threshold, allocates to the central processing unit the message transmission and reception.

8. The server according to claim 6, wherein:
the central processing unit, when the usage rate exceeds a threshold, allocates the message transmission and reception to one of the other plural central processing units.

9. The server according to claim 1, wherein:
one port number is allocated to each of the central processing unit and the other plural central processing units, and the central processing unit controls such that the message transmission and reception is allocated based on the port number.
